(19) United States
(12) Patent Application Publication
(10) Pub. No.: US 2005/0207670 A1
(43) Pub. Date: Sep. 22, 2005

(54) Method of detecting blocking artefacts

(75) Inventors: Estelle Lesellier, Boulogne (FR); Joel Jung, Guyancourt (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., NL-5621 BA Eindhoven (NL)

(21) Appl. No.: 10/518,251

(22) PCT Filed: Jun. 16, 2003
(86) PCT No.: PCT/IB03/02835

§ 371 Date: Dec. 16, 2004

(30) Foreign Application Priority Data
Jun. 25, 2002 (FR) 02/07863

(51) Int. Cl. G06K 9/40

(52) U.S. Cl. 382/275

(57) ABSTRACT

The invention relates to a method of detecting blocking artefacts within a sequence of digital images. The method comprises a step of high-pass filtering a portion of a digital image, intended to supply at least one card of discontinuity pixels. It also comprises a step of detecting blocking artefacts, intended to detect a first type (p1) of elementary blocking artefact and a second type (p2) of elementary blocking artefact from the at least one card of discontinuity pixels. The method finally comprises a step of correcting the blocking artefacts in accordance with their type (p1, p2).

The invention relates to a method of processing data corresponding to pixels of a sequence of digital images so as to detect a grid corresponding to blocking artefacts, said method comprising a step of high-pass filtering a portion of a digital image, intended to supply at least one card of discontinuity pixels, and a step of detecting blocking artefacts from the at least one card of discontinuity pixels.

The invention also relates to a television receiver comprising a processing device for implementing the data processing method according to the invention.

It notably finds its application in the detection of blocking artefacts within a digital image which has been previously encoded and then decoded in accordance with a block-based encoding technique, for example, the MPEG standard (“Motion Pictures Expert Group”), and in the correction of data comprised in these blocks in order to attenuate the visual artefacts caused by the block-based encoding technique.

The blocking artefacts constitute a crucial problem for the block-based encoding techniques using a discrete transform of the discrete cosine transform DCT type. They appear in the form of block mosaics which are sometimes extremely visible in the decoded image sequences. These artefacts are due to a strong quantization subsequent to the discrete transform, which strong quantization causes strong discontinuities to appear at the borders of the encoding blocks.

The article entitled “Optimal JPEG Decoding” by J. Jung, M. Antonini, M. Barlaud, Proc. Of ICIP '98, vol. 1, pp. 410-414, Chicago, October 1998 describes a data processing method with which blocking artefacts can be detected and corrected. To this end, said method comprises a step of frequency transform of the wavelet transform type, which is applied horizontally and vertically to an image. The result of this transform comprises two sub-images which have high-frequency coefficients. These high-frequency coefficients correspond to blocking artefacts or to natural contours. In accordance with the prior-art method, the high-frequency coefficients corresponding to blocking artefacts are spatially located on a grid of 8×8 pixels and have a value which is smaller than a threshold, a value higher than this threshold corresponding to a natural contour.

However, this method is only capable of effecting a basic modeling of the blocking artefacts, which limits its possibilities of detecting said artefacts. Moreover, it only searches the blocking artefacts in 8×8 pixel grids. The grid may be distorted within the image because of a resampling of the image. This distortion may sometimes be known in advance, as in the case of the 3/4 encoding format where the width of the grid varies in accordance with the 10-11-11 pattern. However, in the majority of cases, this variation is arbitrary because it originates, for example, from a rate transcoding, an image format conversion in a 16/9 television receiver, from a 4/3 format into, for example, a 16/9 format a zoom in a portion of the image, an AD conversion, or even a combination of these different conversions. In this case, the prior-art method only detects blocking artefacts in a grid having a fixed size and position and applies a post-processing step based on this detection, with the risk of a partial or even inefficient correction.

It is an object of the invention to propose a data processing method which is more efficient.

To this end, the data processing method according to the invention is characterized in that the detection step is also intended to detect a second type of elementary blocking artefact from the at least one card of discontinuity pixels.

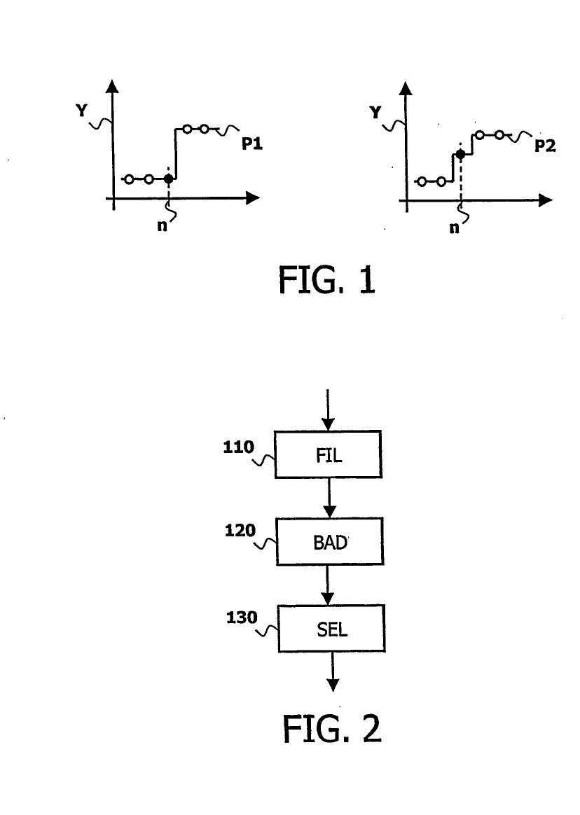

The invention uses the observations illustrated in FIG. 1, representing the evolution of the luminance Y as a function of several consecutive pixels. In accordance with these observations, two types of blocking artefact profiles p1 and p2 are principally encountered in the images which have been encoded and subsequently decoded in accordance with a block-based encoding technique. The first profile p1 corresponds to a standard blocking artefact whereas the second profile p2 corresponds to a blocking artefact which is present in an image that has been subjected to a resampling operation or to an equivalent operation. In the spatial domain, the first profile p1 is a single step of a staircase whereas the second profile p2 is a double step of a staircase.

The method according to the invention also takes the second blocking artefact profile into account by virtue of a more powerful analysis. The modeling thus effected takes a possible resampling operation of the image into account, so that the result obtained in the matter of detecting blocking artefacts is improved. The blocking artefacts may also be detected independently in any grid, thus rendering the processing method more efficient both for detecting and for correcting blocking artefacts.

These and other aspects of the invention are apparent from and will be elucidated, by way of non-limitative example, with reference to the embodiment(s) described hereinafter.

In the drawings:

FIG. 1 illustrates, in the spatial domain, the two artefact profiles p1 and p2 which are principally encountered in the images encoded in accordance with a block-based encoding technique,

FIG. 2 is a diagram showing the data processing method according to the invention,

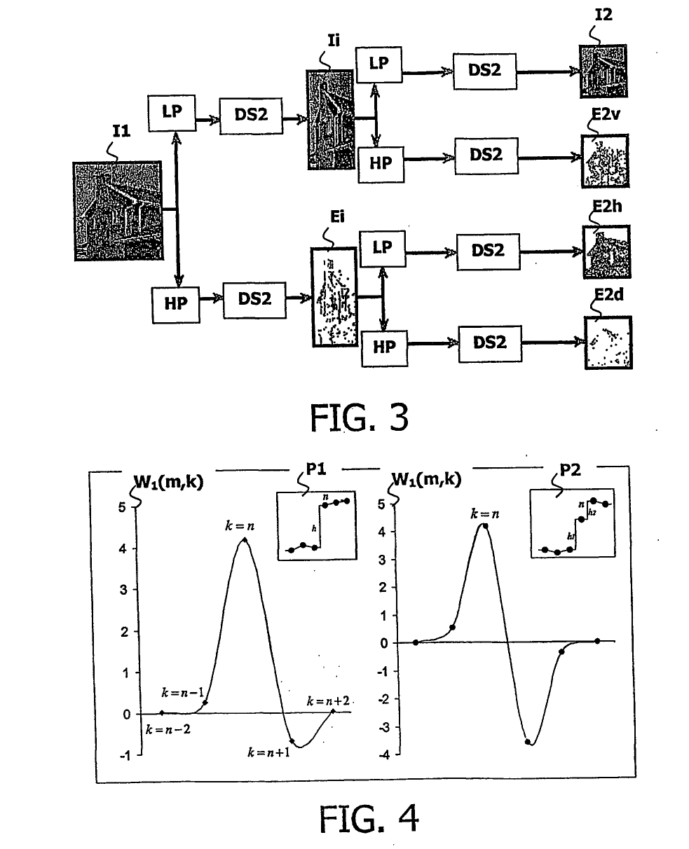

FIG. 3 is a diagram showing a wavelet transform,

FIG. 4 illustrates the two artefact profiles p1 and p2 in the frequency domain after a wavelet transform,

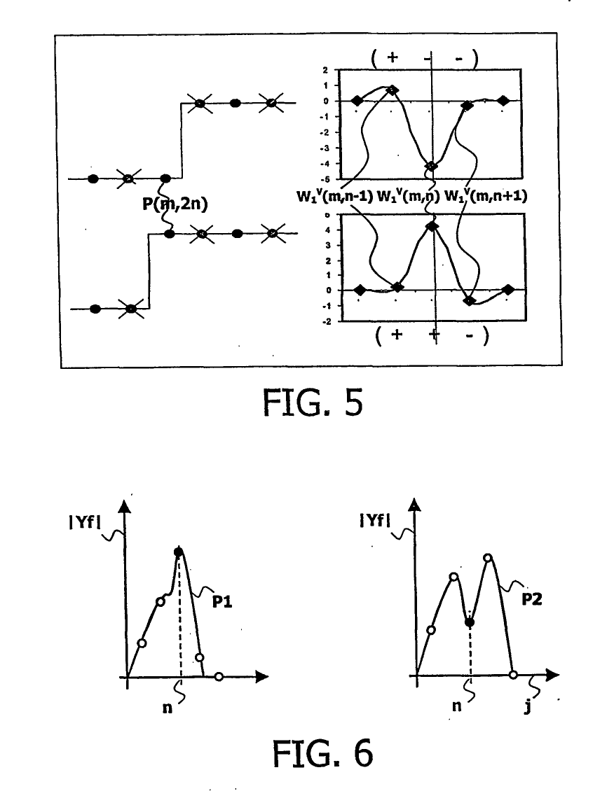

FIG. 5 illustrates the location of a blocking artefact as a function of an artefact profile p1 represented in the frequency domain after wavelet transform,

FIG. 6 illustrates the two artefact profiles p1 and p2 in the frequency domain after processing by a gradient filter,

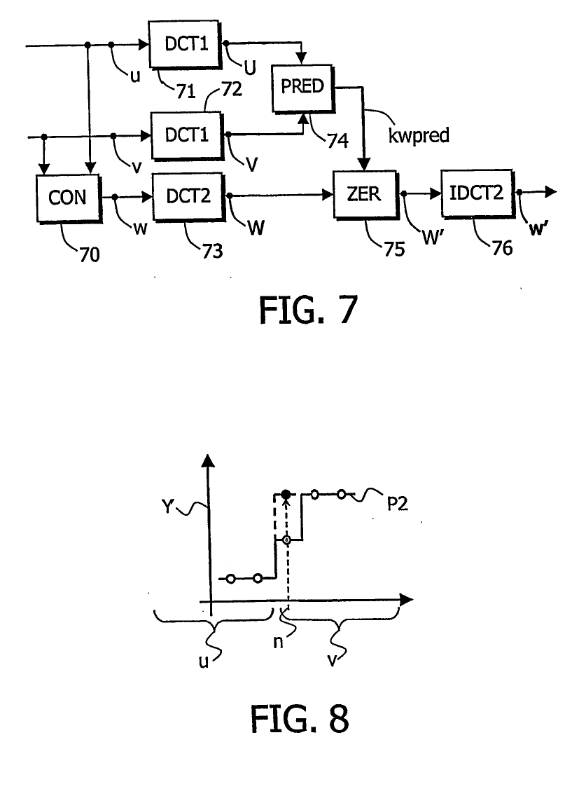

FIG. 7 describes a method of correcting blocking artefacts, and

FIG. 8 describes the principle of correcting a blocking artefact of the p2 type.

The invention relates to a method of processing a sequence of digital images encoded and decoded in accordance with a block-based encoding technique. In our example, the encoding technique used is the MPEG standard based on the discrete cosine transform DCT, but may alternatively be any other equivalent standard, such as, for example, the H.263 or H.26L standard. It should be noted that this method may also be applied to a fixed image, encoded, for example, in accordance with the JPEG standard. The processing method first relates to the detection of blocking artefacts due to these block-based encoding techniques and subsequently to the ensuing application such as, for example, post-processing techniques or image quality measurements.

FIG. 2 shows diagrammatically the processing method according to the invention. Such a method first comprises a step of high-pass filtering FIL (110) a portion of a digital image. This portion is, for example, one of the two fields of a frame if the image is constituted by two interlaced frames. The filter is applied horizontally and vertically, row by row, to pixels of luminance Y(m,n) of the field of a digital image of the sequence, where m and n are integers between 1 and M and between 1 and N, respectively, corresponding to the position of the pixel in the field in accordance with a vertical and horizontal axis, respectively, (M=288 and N=720 in, for example, a 576×720 encoding format).

In the preferred embodiment, the filtering operation is of the wavelet transform type. The wavelet transform, described with reference to FIG. 3, is a signal processing technique which consists of a decomposition of the image into a plurality of sub-bands, a sub-band comprising filtered images of smaller resolution. In our example, the wavelet transform uses a bi-orthogonal decomposition. Such a decomposition has the advantage, on the one hand, that a clear differentiation of the contours by virtue of a high-pass filter is effected and, on the other hand, a smoothing of the image by virtue of a low-pass filter is effected. For obtaining a first sub-band level, the wavelet transform comprises the steps of:
low-pass filtering LP with a filter 1p1 followed by a step of sub-sampling DS2 by 2 along a horizontal direction of the image I1, so as to obtain an image Ii of the texture which is sub-sampled in the horizontal direction, with the low-pass filter 1p1=[0.02674875967204570800; −0.01686411909759044600; −0.07822325080633163500; 0.26686409115791321000; 0.60294902324676514000; 0.26686409115791321000; −0.07822325080633163500; −0.01686411909759044600; 0.02674875967204570800] proposed by Antonini et al. in the article “Image Coding Using Wavelet Transform” IEEE Trans. Image Processing, vol. 1, no. 2, pp. 205-220, April 1992;
high-pass filtering HP with a filter hp1 followed by a step of sub-sampling DS2 by 2 along a horizontal direction of the image I1 so as to detect the discontinuities in the horizontal direction and to obtain a discontinuity image Ei which is sub-sampled in the horizontal direction, with the high-pass filter hp1=[0.045635882765054703, −0.028771763667464256, −0.2956358790397644, 0.5574351615905762, −0.2956358790397644, −0.028771763667464256, 0.045635882765054703] proposed by Antonini et al.;
for each of the two sub-sampled images in the horizontal direction Ii and Ei, a low-pass filtering step LP with a filter 1p1 followed by a step of sub-sampling DS2 by 2 long a vertical direction so as to obtain a sub-sampled image I2 or E2h in the vertical direction, respectively;
for each of the two sub-sampled images in the horizontal direction Ii and Ei, a high-pass filtering step BP with the filter hp1 followed by a step of sub-sampling DS2 by 2 along a vertical direction so as to obtain a discontinuity image E2v or E2d sub-sampled in the vertical direction, respectively.

The result is an approximation image I2 which has a resolution divided by 2 and three detail images E2v, E2h, E2d which give the errors between the original image and the approximate image. The detail images E2h and E2v represent the discontinuities in the horizontal and vertical directions, respectively.

The method also comprises a step of determining the discontinuity corresponding to blocking artefacts BAD (120). Said step is based on forming thresholds and comparisons between a current filtered coefficient and filtered coefficients which are adjacent thereto. FIG. 4 illustrates the two artefact profiles p1 and p2 as well as their representation in the frequency domain: W₁(m,k) as a function of k, k being an integer representing the position of a pixel in the row m, this after wavelet transform such as described hereinbefore.

The method of determining blocking artefacts is described below for the detection of vertical blocking artefacts by considering W₁^{V}(m,k); it is applicable to the detection of the horizontal blocking artefacts by considering W₁^{H}(k,n).

A vertical artefact corresponding to the profile p1 is detected if the following cumulative conditions are satisfied, W₁^{V}(m,n) being a coefficient of the sub-sampled image E2v:
S1<|W₁^{V}(m,n)<S2
|W₁^{V}(m,n)|>A1·|W₁^{V}(m,n±1)|
|W₁^{V}(m,n±2)|<S3
A vertical artefact corresponding to the profile p2 is detected if the following cumulative conditions are fulfilled:
S1<|W₁^{V}(m,n)|<S2 and S1<|W₁^{V}(m,n+1)|<S2
|W₁^{V}(m,n)|>A1·|W₁^{V}(m,n−1)|
|W₁^{V}(m,n+1)|>A1·|W₁^{V}(m,n+2)|
|W₁^{V}(m,n−2)|<S3 and |W₁^{V}(m,n+3)|<S3
A1 is a predetermined coefficient equal to 4 in our example. S1 and S2 are first and second predetermined thresholds, the first threshold corresponding to a visibility threshold, the second threshold to the limit from which the pixel with position (m,n) corresponds to a natural contour. They are equal to 2 and 10, respectively, in our example. S3 is a third threshold obtained from the representation in the frequency domain after wavelet transform of the blocking artefact profiles. In our example, it is equal to 1 and serves to make the detection more reliable by controlling the contrast of the discontinuity. It may be particularly advantageous in the case of MPEG4 applications, where access to video data streams and thus to field quantization steps is possible, to vary the thresholds S1 and S2 as a function of said quantization step so as to further improve the efficiency of the processing method. For example, the threshold values are a linear function of the quantization step.

Because of the sub-sampling by 2 of the decomposition in wavelets, the location at the approximate pixel of the blocking artefact is not an easy matter. Indeed, a coefficient of the frequency domain of the first sub-band may be associated with two pixels in the spatial domain. This is why a finer analysis is necessary, taking into account wavelet coefficient signs W₁^{V}. FIG. 5 shows that a border of the block situated between a pixel p(m,2n−1) and p(m,2n), on the one hand, and a border of the block situated between a pixel p(m,2n) and p(m,2n+1), on the other hand, correspond to a similar profile in the frequency domain, with the exception of signs. Because of the sub-sampling, the sub-sampled pixels p(m,2n−3), p(m,2n−1) and p(m,2n+1) being represented by a cross, the signs of the transformed coefficients W₁^{V}(m,n−1), W₁^{V}(m,n) and W₁^{v}(m,n+1) corresponding to said pixels are (+,−,−) for a block border situated between 2 pixels p(m,2n) and p(m,2n+1), and (+,+,−), respectively, for a block border situated between 2 pixels p(m,2n−1) and p(m,2n) for a discontinuity in the spatial domain having a rising edge. If the discontinuity has a falling edge, the signs of the transformed coefficients W₁^{V}(m,n−1) and W₁^{V}(m,n) corresponding to the sub-sampled pixels p(m,2n−3), p(m,2n−1) and p(m,2n+1) are (−,+,+) and (−,−,+), respectively, in the two preceding cases. In summary, if the signs of the transformed coefficients W₁^{V}(m,n) and W₁^{V}(m,n+1) are identical, then the block border is situated between a pixel p(m,2n) and p(m,2n+1); if the signs of the transformed coefficients W₁^{V}(m,n−1) and W₁^{V}(m,n) are identical, then the block border is situated between a pixel p(m,2n−1) and p(m,2n). Blocking artefacts may be localized for the artefacts having a profile of the type p2 in accordance with a similar principle.

In a particularly advantageous embodiment, the filtering operation is a gradient filtering operation using the filter hp2=[1,−1,−4,8,−4,−1,1]. This filter is applied horizontally and vertically, row by row, to the luminance pixels Y(m,n) of the field of a digital image of the sequence. The result of this filtering operation is preferably constituted by two cards of discontinuity pixels, a horizontal card Eh and a vertical card Ev. As the majority of resampling operations is performed in the horizontal direction, the horizontal card Eh showing the vertical discontinuities may suffice in a first approximation. However, the processing method according to the invention will have an optimal efficiency when it is based on processing the two cards of discontinuity pixels. Other gradient filters are possible such as, for example, the high-pass filter of the wavelet transform hp1 proposed by Antonini et al. The filter hp2 is particularly easy to implement and reliably approximates the filter hp2.

FIG. 6 illustrates the two artefact profiles p1 and p2 in the spatial domain, as well as their representation in the frequency domain after filtering with the filter hp1 or hp2. In the frequency domain, the first profile p1 corresponds to a peak, whereas the second profile p2 corresponds to a double peak.

In this case, the step of determining discontinuities corresponding to blocking artefacts comprises a sub-step of detecting natural contours and non-visible artefacts. To this end, coefficient values filtered horizontally Yfh(m,n) and/or vertically Yfv(m,n) must be between the first and second thresholds S1 and S2 so as to be able to correspond to a blocking artefact. The condition is preferably taken for the absolute value of coefficients filtered as follows:
S1<|Yfh(m,n)|<S2 and S1<|Yfv(m,n)|<S2
As an alternative, the following condition is used:
S′1<|Yfh(m,n)|²+|S′1 Yfv(m,n)|²<S′2,
in which S′1 and S′2 have the same function as S1 and S2.

The threshold values depend on the filter used. For the filter hp1, we take, for example S′1=0.6 and S′2=400, S1=0.5 and S2=20.

The step of determining the discontinuities corresponding to blocking artefacts comprises a sub-step of detecting blocking artefacts. A vertical artefact corresponding to the profile p1 is detected by scanning the field in a horizontal direction corresponding to the row m if the following condition is satisfied:
|Yfv(m,n)|>|Yfv(m,n+k)| with k=−2, −1, +1, +2.
The border of the block is localized between the pixel of position (m,n) and that of position (m,n+1) if |Y(m,n)−Y(m,n−1)|<|Y(m,n)−Y(m,n+1)| and between the pixel of position (m,n−1) and that of position (m,n) in the opposite case.

An artefact corresponding to profile p2 is detected if the following cumulative conditions are satisfied:
f1·|Yfv(m,n)|<(|Yfv(m,n−1)|+|Yfv(m,n+1)|)
|Yfv(m,n−1)|>f2·|Yfv(m,n−2)|
|Yfv(m,n+1)|>f2·|Yfv(m,n+2)|
with f1=6 and f2=2 in the preferred embodiment.

The border of the block is localized between the pixel of position (m,n−1) and that of position (m,1). The detection of a horizontal artefact corresponding to each profile p1 and p2 is effected in a similar manner by scanning the horizontal card Eh comprising the coefficients Yfh(m,n) filtered in a vertical direction corresponding to the column n. The step of determining the discontinuities which has been described hereinbefore has the advantage that it is particularly easy to implement.

A first application of the data processing method according to the invention is constituted by the MPEG detection, i.e. the detection of a sequence of digital images that have been encoded and subsequently decoded in accordance with the MPEG standard and of its grid of blocking artefacts among analog image sequences. This MPEG detection is effected at the level of a television receiver and is generally followed by a step of post-processing images, intended to correct said blocking artefacts which are present in the grid.

To this end, the processing method also comprises a step of selecting SEL (130) segments in a horizontal row or a vertical row of the field, which segments comprise a number of consecutive discontinuity pixels which is higher than a fourth predetermined threshold S0. Indeed, the isolated discontinuities generally correspond to a supplementary noise, while the blocking artefacts which are due to a coarse quantization of the DCT coefficients generally cause linear faults to appear along the encoding blocks. The value S0 of the predetermined threshold must not be too low so as not to favor the false detections. It must neither be too high so as not to constrain the selection too much by reducing the number of segments of detected elementary artefacts. In practice, the value S0 is fixed at 3 for a field of 288 rows of 720 pixels.

Advantageously, the processing method also comprises a step of searching, within the field, a set of grid rows, a grid row having a density of elementary block effects present in the segments which is substantially larger than that of its neighboring rows. Such a step allows an even further reduction of the risk of false detections.

A second application of the data processing method according to the invention is constituted by post-processing images intended, to correct the blocking artefacts which are present in a grid. Said grid has been determined by the method described previously or is known as, for example, the post-processing operation is effected in an MPEG-4 video decoder. The correction depends on the profile of the detected blocking artefact.

If the blocking artefact corresponds to the profile p1, the correction described with reference to FIG. 7 is applied. The method of correcting blocking artefacts comprises the steps of
computing a first discrete cosine transform DCT1 (71) of a first set of N data u situated at the left or above the border of the block;
computing a second discrete cosine transform DCT1 (72) of a second set of N data v situated at the right or below the border of the block and adjacent to the first set;
computing a global discrete cosine transform DCT2 (73) of a set of 2N data w corresponding to the concatenation CON (70) of the first and second sets and providing a set of transformed data W;
determining PRED (74) a predicted maximum frequency kwpred from the transformed data U and V obtained from the first (71) and second (72) transform DCT1, computed in the following manner:
   kwpred=2.max(kamax, kvmax)+2
   with
   kumax=max(kε{0, . . . ,N−1}/abs(U(k))>T),
   kvmax=max(kε{0, . . . ,N−1}/abs(V(k))>T),
   where T is a threshold which is different from zero;
correcting ZER (75) by setting the odd transformed data W from the global discrete cosine transform to zero, whose frequency is higher than the predicted maximum frequency, yielding corrected data W′;
computing an inverse discrete cosine transform IDCT2 (76) of corrected data, yielding filtered data w′ which are subsequently intended to be displayed on the screen.

If the blocking artefact corresponds to the profile p2, the correction must be modified considerably. Indeed, the position of the border of the block must be given more precisely because of the double step of the staircase corresponding to the profile p2, as illustrated in FIG. 8. This is why the correction method preliminarily comprises a step of readjusting the luminance value of the intermediate pixel p(n) intended to give said luminance value the luminance value of the pixel which is situated directly on its right p(n+1). The steps described hereinbefore are then applied, with the border of the block being situated at the left of the intermediate pixel, which then forms part of the segment v.

It is alternatively possible to cause the luminance value of the intermediate pixel to correspond to that of the pixel on the left, or to that of the pixel having the nearest luminance value. In both cases, the positioning of the segments u and v is adapted accordingly so as to apply the correction step.

A third application of the data processing method according to the invention is constituted by measuring the block level of the field from blocking artefacts which are present in the grid so as to determine the quality of the images. The quality measurement may be effected at the level of a television receiver in which the grid has been determined by the method previously described or at the level of an MPEG-4 video decoder, with the grid already being known so as to ensure a given service quality.

The level of the block B of the field f is preferably obtained by summing the amplitudes of the filtered values W₁^{V}(mn) corresponding to elementary blocking artefacts, i.e.

$$B ( f ) = {\sum }_{m , n} ⌊ δ ( ( m , n ) ∈ artV ) κ ( m , n ) \vert {W}_{1}^{V} ( m , n ) \vert + δ ( ( m , n ) ∈ artH ) κ ( m , n ) \vert {W}_{1}^{H} ( m , n ) \vert ⌋$$

wherein δ(x)=1 if x is true and 0 if not, artV and artH comprising the pixels detected as blocking artefacts.

Such a measurement has the advantage that it takes the amplitude W₁ of the degradation into account. It also takes into account the position (m,n) of the degradation, while a weighting coefficient K(m,n) as a function of the perception of the human visual system can be introduced. Moreover, this measurement allows determination of a block level for a grid having an arbitrary dimension or even being variable with respect to time.

It is possible to implement the processing method according to the invention by means of a television receiver circuit, said circuit being suitably programmed. A computer program stored in a programming memory may cause the circuit to perform the different operations described hereinbefore with reference to FIG. 2. The computer program may also be loaded into the programming memory for reading a data carrier such as, for example, a disc comprising said program. The reading operation may also be performed by means of a communication network such as, for example, the Internet. In this case, the service provider will put the computer program in the form of a downloadable signal at the disposal of those interested.

Any reference sign between parentheses in the present text should not be construed as being limitative. Use of the verb “comprise” and its conjugations does not exclude the presence of elements or steps other than those stated in the claims. Use of the article “a” or “an” preceding an element or step does not exclude the presence of a plurality. of such elements or steps.

1. A method of processing data corresponding to pixels of a sequence of digital images so as to detect blocking artefacts, said method comprising a step of high-pass filtering (110) a portion of a digital image, intended to supply at least one card of discontinuity pixels, and a step of detecting (120) blocking artefacts, intended to detect a first type (p1) of elementary blocking artefact from the at least one card of discontinuity pixels, said method being characterized in that the detection step is also intended to detect a second type (p2) of elementary blocking artefact from the at least one card of discontinuity pixels.

2. A data processing method as claimed in claim 1, wherein the high-pass filtering step (110) is suitable for using a wavelet transform, intended to supply at least one card of sub-sampled discontinuity pixels corresponding to a sub-band of said transform.

3. A data processing method as claimed in claim 2, also comprising a step of localizing the elementary blocking artefact in a row of the portion of the digital image from signs of filtered values of the sub-sampled pixels of the card of discontinuity pixels.

4. A data processing method as claimed in claim 1, wherein the high-pass filtering step is intended to supply two cards of discontinuity pixels, one horizontal card and one vertical card.

5. A data processing method as claimed in claim 1, wherein the high-pass filtering step is suitable for using a gradient filter.

6. A data processing method as claimed in claim 1, comprising a step of measuring the image quality, intended to provide a blocking artefact level from filtered values of the pixels corresponding to the blocking artefacts.

7. A data processing method as claimed in claim 1, comprising a step of correcting the blocking artefacts in accordance with their type (p1, p2).

8. A television receiver comprising a processing device using the data processing method as claimed in claim 7, suitable for detecting blocking artefacts within a sequence of digital images and for correcting them with a view to displaying a sequence of corrected digital images on a screen of said receiver.

9. A video decoder suitable for providing a sequence of decoded digital images and comprising a processing device using the processing method as claimed in claim 7, suitable for detecting blocking artefacts within the sequence of decoded digital images and for correcting them so as to provide a sequence of corrected digital images.

10. A computer program product comprising a set of instructions which, when loaded into a circuit, cause said circuit to perform the method of processing digital images as claimed in claim 1.
